(19) United States
(12) Patent Application Publication
(10) Pub. No.: US 2014/0308492 A1
(43) Pub. Date: Oct. 16, 2014

(54) SOUND-ABSORBING COMPOSITE AND ITS USE

(71) Applicant: Bayer Intellectual Property GmbH, Monheim (DE)

(72) Inventors: Rolf Albach, Koln (DE); Joern Beaujean, Leverkusen (DE)

(73) Assignee: Bayer Intellectual Property GmbH, Monheim (DE)

(21) Appl. No.: 14/222,826

(22) Filed: Mar. 24, 2014

(30) Foreign Application Priority Data
Mar. 25, 2013 (EP) 13160923.2

(51) Int. Cl. E04B 1/86; B32B 27/40; B32B 27/08; B32B 5/32

(52) U.S. Cl. CPC E04B 1/86; B32B 5/32; B32B 27/40; B32B 27/08; E04B 2001/8461
USPC 428/215; 252/62

(57) ABSTRACT

The present invention relates to composite elements comprising a layer of open-cell, hard, isocyanate-based foam and at least one further layer of isocyanate-based foam, and to their use for sound absorption.

### FIELD OF THE INVENTION

The present invention relates to composite elements comprising a layer of open-cell, hard, isocyanate-based foam and at least one further layer of isocyanate-based foam, and to their use for sound absorption.

### BACKGROUND OF THE INVENTION

For reducing ambient noise in indoor areas it is nowadays common to use sound-absorbing walls. Employed presently for this purpose are fibre nonwovens or flexible foams, often also in multi-ply constructions, which frequently are not self-supporting and are fixed by an internal or external framework. The company Silence Solutions offers sound-absorbing partition walls of this kind (DE-A 102007000568).

A framework also leads to considerable weight. In mass-spring systems, a lightweight and flexible ply (also called layer) is combined with a heavier, harder and non-porous ply, which likewise form constructions of corresponding heaviness.

Alternatively there are also open-cell, lightweight rigid foams known, based on urea and formaldehyde, but producing them is costly and complicated, since it is necessary to minimize the emissions of formaldehyde into the indoor air. Achieving low formaldehyde emissions is much easier, for example, when using polyurethane.

Motor vehicles often contain, in their roof lining, polyurethane foams with various densities and hardnesses, supported by glass fibre/polyurea composites.

Additionally known are combinations of different materials for the production of acoustically active composites.

JP-A 2010184655 describes two-ply composites. In these composites, one ply is an open-cell rigid or flexible polyurethane foam based on polyester polyol, with a JIS A 1405-1 absorption maximum in the 500-1000 Hz range. The second ply is a foam based on polystyrene resin, phenolic resin, urethane resin and/or melamine resin, with an air permeability of 100 ml/cm²/s.

JP-A 2005193612 describes a rigid integral foam in the form of a three-ply construction, composed of two heavy layers at 100-300 kg/m³ and of a rigid polyurethane foam core having a density of 10-70 kg/m³. One of the heavy outer layers must be subsequently perforated at additional effort and cost, in order to obtain effective acoustic absorption.

JP-A 2009226675 describes a two-ply sound absorber comprising foam and directly foamed-on fibre nonwoven. The foaming-on of fibre nonwoven is a very demanding operation from a technical standpoint.

JP-A 2005352036 describes a three-ply sound absorber composed of three foams, the first foam having a density of 60-130 kg/m³, a Young's modulus of 1.5-3.5 10⁵ N/m² and an airflow resistance of 1000-8000 Ns/m³, the second a density of 45-80 kg/m³ and a Young's modulus of 1-10 10⁵ N/m², and the third a density of 100-200 kg/m³ and an airflow resistance of 800-6000 Ns/m³.

The object was to provide sound-absorbing and particularly rigid composites with which it is possible to reduce the ambient noise in indoor areas, so that noise-related detrimental effects on health and well-being are minimized.

Surprisingly it has been found that this object can be achieved with a composite element comprising at least two foam layers based on isocyanates with different hardnesses.

### EMBODIMENTS OF THE INVENTION

The invention provides a composite element comprising at least two layers, of different isocyanate-based foams, each having a DIN 53420 density of ≦130 kg/m³, preferably ≦100 kg/m³, and each having a DIN EN 826 compressive strength of 5 to 200 kPa at 10% compression, the densities and compressive strengths of the at least two layers being different, with at least one of the at least two layers having a DIN 53430 elongation at break of greater than 30%, and each having on average 75 to 98% of open cells to DIN ISO 4590-86, and which optionally have an adhesive bonding layer between the at least two layers, wherein
A) at least one of the at least two foam layers is at least 5 mm thick and consists of an irreversibly thermoformable, hard isocyanate-based foam having a DIN 53420 density of 10-45 kg/m³, preferably of 15-30 kg/m³, and a DIN EN 826 compressive strength at 10% compression of 30-200 kPa, the foam layer A) obtained from the reaction of the components consisting of
   i) a polyol component consisting of
      a. 15-60 wt %, based on the total amount of the isocyanate-reactive components of the polyol component i), of a polyether polyol with 10-50 wt % ethylene oxide fraction, having a number-average equivalent weight of 500-2500 g/mol and a functionality of 2 to 8, preferably 2 to 6,
      b. 30-70 wt %, based on the total amount of the isocyanate-reactive components of the polyol component i), of a polyether polyol having a number-average equivalent weight of 50-480 g/mol and a functionality of 2 to 8, preferably 2 to 6,
      c. optionally a chain extender and/or a crosslinking agent,
      d. 1 to 15 wt %, based on the total amount of the isocyanate-reactive components of the polyol component i), of water and optionally further a blowing agent,
      e. 0.3 to 5 wt %, based on the total amount of the isocyanate-reactive components of the polyol component i), of a catalyst,
      f. optionally an auxiliary and/or an adjuvant,
   ii) and an isocyanate component comprising
      g. 55 to 100 wt %, preferably 60 to 80 wt %, based on the isocyanate component ii), of difunctional diphenylmethane diisocyanate (MDI) having an isomer weight ratio of 4,4′-MDI to 2,4′-MDI of 1:1 to 7:1, preferably of 2:1 to 3:1,
      h. 0 to 45 wt %, preferably 20 to 40 wt %, based on the isocyanate component ii), of a higher homologues of diphenylmethane diisocyanate (MDI),
B) the at least two foam layers each have at least an average sound absorption of 20% at a layer thickness of 1 cm in the range of 315-6350 Hz to ISO 10543.

With particular preference, both of the at least two layers have a thickness of at least 5 mm.

In one preferred embodiment, a hard foam A) having a (DIN EN 826) compression hardness at 10% compression of 30 to 200 kPa, as one layer, and a flexible foam having a (ISO 3386-1-98) compression hardness at 40% compression of 0.5 to 50 kPa, as second layer, are combined. With each of the two aforementioned layers in the composite having a thickness of 5 mm, the composite already has a sufficient acoustic efficiency.

In one particularly preferred embodiment, both layers are isocyanate-based foams having a DIN 53420 density of 10 to 45 kg/m³, preferably 15 to 24 kg/m³, with one layer having a DIN EN 826 compressive strength at 10% compression of 60 to 200 kPa, and with the density relative to the foam layer A) differing by 3 to 20 kg/m³.

Another embodiment of the invention is a method for producing a sound-absorbing panel comprising utilizing the above composite element.

### DETAILED DESCRIPTION OF THE INVENTION

The composite elements of the invention are preferably produced such that one or else two or more foam layer(s) A) are fixed to the wall of a mould. Then a mixture of a polyol component and an isocyanate component is introduced into the open or closed mould. The mould is closed, if appropriate, and the mixture is cured in the mould to form a foam layer.

The composite elements of the invention are used more particularly for producing sound-absorbing panels which require no external frame for stabilization. This is of considerable importance particularly in the case of weight-sensitive mobile applications, such as in vehicles, for example.

Used as component a. are di- to octafunctional, ethylene oxide-containing polyoxyalkylene polyols having an equivalent weight of 500-2500 g/mol, which are obtainable preferably by reaction of ethylene oxide and/or propylene oxide with di- to octafunctional starter molecules, such as, for example, glycerol, trimethylolpropane, ethylene glycol, water, 1,2-propylene glycol, neopentyl glycol, bisphenol A, bisphenol F, tetrabromobisphenol A, sorbitol sucrose and other starters.

Used as component b. are di- to octafunctional, preferably di- to hexafunctional, more preferably di- to trifunctional polyoxyalkylene polyols having an equivalent weight of 50-480 g/mol, which are obtainable preferably by reaction of ethylene oxide and/or propylene oxide with starters, such as, for example, glycerol, trimethylolpropane, propanediols, ethanediol, triethanolamine, ethylenediamine, alkylated diaminobenzene, mixtures of sugar and/or sorbitol with glycols, the monoester of phthalic acid with glycols, and others.

Employed as component c. may be the compounds known per se from polyurethane chemistry, such as, for example, glycerol, butanediol, ethylene glycol, diethylene glycol, isosorbitol, triethanolamine and diethanolamine.

As further blowing agents under d. it is possible in particular to use physical blowing agents, formic acid and formates.

Catalysts e. include compounds which accelerate the reaction. Those contemplated include organometallic compounds, preferably organotin compounds, such as tin(II) salts of organic carboxylic acids, for example tin(II) acetate, tin(II) octoate, tin(II) ethylhexanoate, tin(II) laurate and the dialkyl tin(IV) salts of organic carboxylic acids, for example dibutyltin diacetate, dibutyltin dilaurate, dibutyltin maleate, dioctyltin diacetate, bismuth salts and zinc salts, and also tertiary amines such as triethylamine, tributylamine, dimethylcyclohexylamine, dimethylbenzylamine, N-methylimidazole, N-methyl-, N-ethyl- and N-cyclohexylmorpholine, N,N,N′,N′-tetramethylethylenediamine, N,N,N′,N′-tetramethylbutylenediamine, N,N,N′,N′-tetramethylhexylene-1,6-diamine, pentamethyldiethylenetriamine, tetramethyldiaminoethyl ether, bis(dimethylaminopropyl)urea, dimethylpiperazine, 1,2-dimethylimidazole, 1-azabicyclo[3,3,0]octane, 1,4-diazabicyclo[2,2,2]octane, and alkanolamine compounds such as triethanolamine, trisisopropanolamine, N-methyl- and N-ethyldiethanolamine and dimethylethanolamine and also the corresponding amine oxides. Further contemplated as catalysts are the following: tris(dialkylamino)-s-hexahydrotriazines, especially tris(N,N-dimethylamino)-s-hexahydrotriazine, tetraalkylammonium salts such as, for example, N,N,N-trimethyl-N-(2-hydroxypropyl) ammonium formate, N,N,N-trimethyl-N-(2-hydroxypropyl) ammonium-2-ethylhexanoate, tetraalkylammonium hydroxides such as tetramethylammonium hydroxide, alkali metal hydroxides such as sodium hydroxide, alkali metal alkoxides such as sodium methoxide and potassium isopropoxide, and also alkali metal salts or alkaline earth metal salts of fatty acids having 1 to 20 C atoms and optionally pendant OH groups.

Also used preferably as catalysts e. are isocyanate-reactive tertiary amines such as, for example, N,N-dimethylaminopropylamine, bis(dimethylaminopropyl)amine, N,N-dimethylaminopropyl-N′-methylethanolamine, dimethylaminoethoxyethanol, bis(dimethylaminopropyl)amino-2-propanol, N,N-dimethylaminopropyldipropanolamine, N,N,N′-trimethyl-N′-hydroxyethylbisaminoethyl ether, N,N-dimethylaminopropyl urea, N-(2-hydroxypropyl)imidazole, N-(2-hydroxyethyl)imidazole, N-(2-aminopropyl)imidazole, 2-((dimethylamino)ethyl)methylaminopropanol, 1,1′-((3-(dimethylamino)propyl)imino)bis-2-propanol and/or the reaction products, described in EP-A 0 629 607, of ethyl acetoacetate, polyether polyols and 1-(dimethylamino)-3-aminopropane.

Typical auxiliaries and/or adjuvants f. for the production of isocyanate-based foams are foam stabilizers, emulsifiers, colorants, flame retardants and cell openers.

Emulsifiers include, for example, ethoxylated alkylphenols, alkali metal salts of fatty acids, betaines, alkali metal salts of sulphated fatty acids, alkali metal salts of sulphonic acids, and salts of fatty acids and amines.

Suitable foam stabilizers include, for example, siloxane-polyoxyalkylene copolymers, organopolysiloxanes, ethoxylated fatty alcohols and alkylphenols, fatty acid-based amine oxides and betaines, and castor oil or ricinoleic esters.

Active cell openers include, for example, paraffins, polybutadienes, fatty alcohols and optionally polyalkylene oxide-modified dimethylpolysiloxanes.

Further examples of auxiliaries and/or adjuvants f. for optional use are reaction retarders, stabilizers against effects of ageing and weathering, plasticizers, inorganic flame-retarding substances, optionally modified carbon blacks, graphites and other carbons, phosphorus- and/or halogen-containing organic flame retardants, substances with fungistatic and bacteriostatic activity, pigments and dyes, and also the customary organic and inorganic fillers that are known per se.

Further details on mode of use and mode of action of the aforementioned auxiliaries and/or adjuvants are described for example in Kunststoff-Handbuch, Polyurethane, volume VII, Carl Hanser Verlag, Munich, Vienna, 2^{nd} edition, 1983.

In the isocyanate component ii) it is additionally possible to use di- and/or polyisocyanates of the diphenylmethane series that are liquid at room temperature. These include room-temperature-liquid and optionally correspondingly modified mixtures of 4,4′-diisocyanatodiphenylmethane, 2,4′- and optionally 2,2′-diisocyanatodiphenylmethane. Also highly suitable are room-temperature-liquid polyisocyanate mixtures of the diphenylmethane series which as well as the stated isomers include their higher homologues and which are obtainable in a manner known per se by phosgenation of aniline/formaldehyde condensates. Also suitable are modification products of these di- and polyisocyanates that have urethane groups and/or carbodiimide/uretdione groups. Modification products of the stated di- and polyisocyanates that have allophanate and/or biuret groups are likewise suitable. In minor amounts there may be further aliphatic, cycloaliphatic or aromatic polyisocyanates present in the component ii).

The isocyanate component (ii) preferably has an average NCO functionality of 2.1 to 5.0, preferably 2.5 to 3.1.

The examples which follow are intended to elucidate the invention in more detail.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Example I

### Production of Foam A

Foam A was produced by first mixing, in a paper beaker of 0.66 dm³ volume, a mixture of 61.86 parts by weight of glycerol-started, ethylene oxide-terminated polypropylene oxide (6000 g/mol), 0.83 part by weight of glycerol-started, ethylene oxide-terminated polypropylene oxide (4550 g/mol), 0.29 part by weight of diethanolamine, 0.54 part by weight of glycerol, 1.68 part by weight of water, 0.17 part by weight of Tegostab B8734LF2, 0.13 part by weight of Tegocolor Black HI and 1.08 part by weight of PC CAT NP712, this mixing being carried out for ten seconds at 200 Hz with a Pendraulik stirrer (6.5 cm stirring plate diameter), and loading the mixture with air. Then 32.75 parts by weight of a mixture of 2,4′-MDI, 4,4′-MDI, the biuret of 4,4′-MDI, and higher MDI homologues were added. The mixture was mixed with the same stirrer at 700 Hz for 5 seconds. The foam began to rise 5 seconds after the addition of the isocyanate and commencement of mixing. The foam rose for a further 50 seconds. After the foam had cured, the projecting dome was cut off with a knife at the edge of the beaker. After subtraction of the beaker weight, 28.4 grams of foam were found to be present in 0.66 dm³ beaker volume. This corresponds to a density of 43 kg/m³. For the production of the foam slices for the acoustic measurements, in analogy to the formula indicated above, 208 grams of the polyol/isocyanate mixture were introduced into an aluminium mould of 2*2*0.4 m³ volume. After the lid had been locked on, the foam cured in the mould for 2 minutes. The test specimens for the acoustic measurements were cut from the core of the foam panel. The density of the foam in the core (DIN53420) is 120 grams/dm³. The tensile strength is 315 kPa, the elongation at break 87% (ISO 1798). The compression hardness at 40% compression is 30 kPa (ISO 3386-1-98).

### Example II

### Production of Foam B

Foam B was produced by first mixing, in a metal-based paper beaker of 0.93 dm³ volume, a mixture of 7.7 parts by weight of glycerol-started, ethylene oxide-terminated polypropylene oxide (6000 g/mol), 14.64 parts by weight of ethylene oxide-terminated, propylene glycol-started polypropylene oxide (4000 g/mol), 3.85 parts by weight of propylene glycol-started, ethylene oxide-terminated polypropylene oxide (2000 g/mol), 3.78 parts by weight of ortho-tolylenediamine-started, ethylene oxide-terminated polypropylene oxide (490 g/mol), 1.63 parts by weight of ethylenediamine-started polypropylene oxide (350 g/mol), 3.63 parts by weight of water, 0.54 part by weight of Ortegol 501, 0.18 part by weight of Tegostab B8870, 0.18 part by weight of Isopur N black paste and 0.73 part by weight of Desmorapid 59IF08 catalyst, this mixing being carried out for ten seconds at 200 Hz using a Pendraulik stirrer (6.5 cm stirring plate diameter), and loading the mixture with air. Then 63.13 parts by weight of a mixture of 2,4′-MDI, 4,4′-MDI and higher MDI homologues (weight ratio 23:51:26) were added. The mixture was mixed with the same stirrer at 700 Hz for 10 seconds and poured into a wooden box lined with Teflon sheet and having a volume of 3*3*3 dm³. 140 seconds after addition of the isocyanate and commencement of mixing, it became possible for the first time to draw threads from the foam using a match. After a further two minutes, the foam was demoulded and left to stand for 24 hours. Then a cube of 1 dm edge length was cut from the core. The cube weighs 17 grams. This corresponds to a density of 17 kg/m³. The test specimens for the acoustic measurements were cut from the foam in the middle, above the central cube utilized for determining the gross density. The tensile strength is 97 kPa, the elongation at break 20% (DIN 53430). The compression hardness is 64 kPa (EN 826). The open-cell content is 95% (DIN ISO 4590-86).

### Example III

### Production of Foam C

Foam C was produced by first mixing, in a metal-based paper beaker of 0.93 dm³ volume, a mixture of 12.09 parts by weight of glycerol/sorbitol-co-started polypropylene oxide with ethylene oxide cap (6000 g/mol), 3.84 parts by weight of polypropylene glycol (400 g/mol), 15.93 parts by weight of glycerol-started polypropylene oxide (510 g/mol), 2.3 parts by weight of glycerol, 2.5 parts by weight of water, 0.58 part by weight of Polyurax SR272, 0.19 part by weight of Isopur N black paste, 1.15 part by weight of a reaction product of oleic acid and dimethylaminopropylamine (molar ratio 1:1), this mixing being carried out using a Pendraulik stirrer (6.5 cm stirring plate diameter) at 200 Hz for 10 seconds, and loading the mixture with air. Then 61.42 parts by weight of a mixture of 2,4′-MDI, 4,4′-MDI and higher MDI homologues (weight ratio 23:51:26) were added. The mixture was mixed with the same stirrer at 700 Hz for 10 seconds and poured into a wooden crate lined with Teflon sheet and with a volume of 3*3*3 dm³. After five minutes, the foam was demoulded and left to stand for 24 hours. Then a cube of 1 dm edge length was cut from the core. The cube weighs 24 grams. This corresponds to a density of 24 kg/m³. The test specimens for the acoustic measurements were cut from the core of the foam at the top, middle and bottom. Values reported are average values from these three panels. The tensile strength is 115 kPa, the elongation at break 14% (DIN 53430). The compression hardness is 96 kPa (EN 826). The open-cell content is 84% (DIN ISO 4590-86).

### Example IV

### Production of Foam D

Foam D was produced by first mixing, in a paper beaker of 0.66 dm³ volume, a mixture of 62.8 parts by weight of glycerol-started, ethylene oxide-terminated polypropylene oxide (6200 g/mol), 0.33 part by weight of glycerol, 2.33 parts by weight of water, 0.5 part by weight of Tegostab B8734LF2, 0.13 part by weight of Tegocolor Black HI, 0.27 part by weight of Jeffcat DMAPA and 0.27 part by weight of PC CAT NP712, this mixing being carried out for 10 seconds at 200 Hz with a Pendraulik stirrer (6.5 cm stirring plate diameter), and loading the mixture with air. Then 33.7 parts by weight of a mixture of 2,4′-MDI, 4,4′-MDI, the biuret of 4,4′-MDI, and higher MDI homologues (1:68:20:11) were added. The mixture was mixed with the same stirrer at 700 Hz for 5 seconds. The foam began to rise 13 seconds after the addition of the isocyanate and commencement of mixing. The foam rose for a further 54 seconds. After the foam had cured, the projecting dome was cut off with a knife at the edge of the beaker. After subtraction of the beaker weight, 38.9 grams of foam were found to be present in 0.66 dm³ beaker volume. This corresponds to a density of 59 kg/m³.

For the production of the foam slices for the acoustic measurements, in analogy to the formula indicated above, 106 grams of the polyol/isocyanate mixture were introduced into an aluminium mould of 2*2*0.4 m³ volume. After the lid had been locked on, the foam cured in the mould for 2 minutes. The test specimens for the acoustic measurements were cut from the core of the foam panel. The density of the foam in the core (DIN53420) is 64 grams/dm³. The tensile strength is 223 kPa, the elongation at break 150% (ISO 1798). The compression hardness at 40% compression is 9 kPa (ISO 3386-1-98).

Composite elements without adhesive layer were produced from the foams A, B, C, D and E produced, using mechanical clamping (examples 1 to 13; see table 1).

Example V

### Production of Foam E and of the Composite Elements (Examples 14 to 16; See Table 1) of Foam E with Foam C

Foam E was produced by mixing a mixture of 60.23 parts by weight of propylene glycol-started, ethylene oxide-terminated polypropylene oxide (6200 g/mol), 0.49 part by weight of diethanolamine, 2.42 parts by weight of water, 0.2 part by weight of Tegostab B8734LF2, 0.2 part by weight of Isopur N black paste, 1.96 part by weight of Mesamoll, 0.16 part by weight of Jeffcat ZF10, 0.68 part by weight of dimethylaminohexanol and 0.04 part by weight of Dabco NE300, this mixing taking place using a Pendraulik stirrer (6.5 cm stirring plate diameter) at 200 Hz for 10 seconds, and loading the mixture with air. Then 33.45 parts by weight of a mixture of 2,4′-MDI, 4,4′-MDI and higher MDI homologues were added. The mixture was mixed with the same stirrer at 700 Hz for 5 seconds. The mixture was introduced into a temperature-conditioned folding-lid mould of 1.6 dm³ volume, into which a type C foam panel 10 mm thick had been fixed beforehand into the base or lid. In one instance, the foam panel inserted in each case was moistened. After three minutes the mould was opened.

The test specimens for the acoustic measurements were cut from the composite so as to produce 5 mm of type C foam and 5 mm of type E foam. From the excess foam of type E, test specimens were cut for determining the mechanical properties. The density of the foam in the core (DIN53420) is 53 grams/dm³. The tensile strength is 141 kPa, the elongation at break 135% (ISO 1798). The compression hardness at 40% compression is 4 kPa (ISO 3386-1-98).

The properties of the composite elements and their construction can be seen from table 1 below.

TABLE 1

| | Foam | | | | | |
|---|---|---|---|---|---|---|
| | remote | | | | | |
| | from the | Foam facing | | | | |
| | sound | the sound | Average | Average | Average | |
| | source | source | foam | absorption | absorption | Max. |
| | Layer thickness | | density | 315-6350 Hz | 315-630 Hz | absorption |
| Examples | 5 mm | 5 mm | (kg/m³) | ISO 10543 | ISO 10543 | ISO 10543 |
| 1* | A | A | 120 | 38% | 11% | 69% (6350 Hz) |
| | | | | | | 41% (1600 Hz) |
| 2* | B | B | 17 | 22% | 10% | 52% (6350 Hz) |
| | | | | | | 27% (3150 Hz) |
| 3* | C | C | 24 | 36% | 6% | 74% (6350 Hz) |
| | | | | | | 42% (1600 Hz) |
| 4* | D | D | 64 | 36% | 7% | 97% (5000 Hz) |
| | | | | | | 62% (3150 Hz) |
| 5* | E | E | 54 | 28% | 5% | 89% (6350 Hz) |
| 6 | A | C | 72 | 28% | 14% | 66% (1600 Hz) |
| 7 | C | A | 72 | 39% | 10% | 89% (6350 Hz) |
| 8 | C | D | 44 | 48% | 9% | 97% (3150 Hz) |
| 9 | D | C | 44 | 38% | 8% | 99% (6350 Hz) |
| 10 | B | C | 21 | 32% | 16% | 64% (3150 Hz) |
| 11 | C | B | 21 | 43% | 11% | 93% (4000 Hz) |
| 12 | B | D | 40 | 37% | 16% | 68% (5000 Hz) |
| 13 | D | B | 40 | 35% | 10% | 89% (6350 Hz) |
| 14 | E | C | 39 | 41% | 12% | 75% (2500 Hz) |
| | | (in lid) | | | | |
| 15 | E | C | 39 | 41% | 12% | 72% (4000 Hz) |
| | | (in lid, | | | | |
| | | moistened) | | | | |
| 16 | E | C | 39 | 35% | 9% | 79% (6350 Hz) |
| | | (in base) | | | | |

*Comparative examples

Examples 8 and 9 (combinations CD, DC) show that the combination of a low-density rigid foam (foam C) with a very low-density rigid foam (foam D) generally produce an improvement in sound absorption, even when the difference in densities is only 7 kg/m³.

Examples 7 and 11 (combinations CA, CB) show that the combination of a low-density rigid foam (foam C) on the side remote from the noise with another open-cell foam produce a general enhancement in noise absorption. This is also the case if instead of the low-density rigid foam (foam C), a particularly lightweight foam D is employed. In the case of a BD combination, sound absorption is improved very particularly in the low-frequency range. In the case of the direct foaming-on process (examples 14, 15), a general enhancement in absorption is achieved even when the low gross-density rigid foam (foam C) is placed on the noise-facing side and the flexible foam on the side remote from the noise.

Example 6 and 10 (combinations AC, BC) show that the combination of a flexible foam and a low-density rigid foam on the noise-facing side produces an improvement in the low-frequency range.

Examples 8, 10, 11, 12, 14 and 15 show that it is also possible by means of foam combinations, surprisingly, to obtain particularly high absorptions in the form of a selective filter function selectively at certain frequencies.

1. A composite element comprising at least two layers, each with a thickness of at least 5 mm, of different isocyanate-based foams, each having a DIN 53420 density of 130 kg/m³ and each having a DIN EN 826 compressive strength of 5 to 200 kPa at 10% compression, the densities and compressive strengths of the at least two layers being different, with at least one of the at least two layers having a DIN 53430 elongation at break of greater than 30%, and each having on average 75 to 98% of open cells to DIN ISO 4590-86, and which optionally have an adhesive bonding layer between the at least two layers, wherein
A) at least one of the at least two foam layers consists of an irreversibly thermoformable, hard isocyanate-based foam having a DIN 53420 density of 10-45 kg/m³ and a DIN EN 826 compressive strength at 10% compression of 30-200 kPa, the foam layer A) obtained from the reaction of the components consisting of
i) a polyol component consisting of
a. 15-60 wt %, based on the total amount of the isocyanate-reactive components of the polyol component i), of a polyether polyol with 10-50 wt % ethylene oxide fraction, having a number-average equivalent weight of 500-2500 g/mol and a functionality of 2 to 8,
b. 30-70 wt %, based on the total amount of the isocyanate-reactive components of the polyol component i), of a polyether polyol having a number-average equivalent weight of 50-480 g/mol and a functionality of 2 to 8,
c. optionally a chain extender and/or a crosslinking agent,
d. 1 to 15 wt %, based on the total amount of the isocyanate-reactive components of the polyol component i), of water and optionally further a blowing agent,
e. 0.3 to 5 wt %, based on the total amount of the isocyanate-reactive components of the polyol component i), of a catalyst,
f) optionally an auxiliary and/or an adjuvant,
ii) and an isocyanate component comprising
g) 55 to 100 wt %, based on the isocyanate component ii), of difunctional diphenylmethane diisocyanate (MDI) having an isomer weight ratio of 4,4′-MDI to 2,4′-MDI of 1:1 to 7:1,
g) 0 to 45 wt %, based on the isocyanate component ii), of a higher homologue of diphenylmethane diisocyanate (MDI),
B) the at least two foam layers each have at least an average sound absorption of 20% at a layer thickness of 1 cm in the range of 315-6350 Hz to ISO 10543 (Kund's tube).

2. A method for producing a sound-absorbing panel comprising utilizing the composite element according to claim 1.
